(19) United States
(12) Patent Application Publication
(10) Pub. No.: US 2022/0318627 A1
(43) Pub. Date: Oct. 6, 2022

(54) TIME SERIES RETRIEVAL WITH CODE UPDATES

(71) Applicant: NEC Laboratories America, Inc., Princeton, NJ (US)

(72) Inventors: Takehiko Mizoguchi, Princeton, NJ (US); Cristian Lumezanu, Princeton Junction, NJ (US); Yuncong Chen, Plainsboro, NJ (US); Haifeng Chen, West Windsor, NJ (US)

(21) Appl. No.: 17/713,412

(22) Filed: Apr. 5, 2022

Related U.S. Application Data
(60) Provisional application No. 63/171,203, filed on Apr. 6, 2021.

(51) Int. Cl. G06N 3/08; G06K 9/62

(52) U.S. Cl. CPC G06N 3/08; G06K 9/6201; G06K 9/6218; G06K 9/6232

(57) ABSTRACT

Methods and systems for training a model include training a feature extraction model to extract a feature vector from a multivariate time series segment, based on a set of training data corresponding to measurements of a system in a first domain. Adapting the feature extraction model to a second domain, based on prototypes of the training data in the first domain and new time series data corresponding to measurements of the system in a second domain.

### RELATED APPLICATION INFORMATION

This application claims priority to U.S. Patent Application No. 63/171,203, filed on Apr. 6, 2021, incorporated herein by reference in its entirety.

### BACKGROUND

### Technical Field

The present invention relates to time series management, and, more particularly, to retrieval of time series by updated binary codes.

### Description of the Related Art

Complex cyber-physical systems can generate time series data from a variety of sensors, with measurements being taken periodically from each of the sensors. The resulting multivariate time series data can be used to characterize the behavior of the cyber-physical system, but the data can be voluminous and difficult to manage.

### SUMMARY

A method for training a model includes training a feature extraction model to extract a feature vector from a multivariate time series segment, based on a set of training data corresponding to measurements of a system in a first domain. Adapting the feature extraction model to a second domain, based on prototypes of the training data in the first domain and new time series data corresponding to measurements of the system in a second domain.

A method for anomaly detection includes training a feature extraction model to extract a feature vector from a multivariate time series segment, based on a set of training data corresponding to measurements of a system in a first domain. New time series data is collected from a plurality of sensors. The new time series data corresponding to a second domain of the system. The feature extraction model is adapted to a second domain, based on prototypes of the training data in the first domain and the new time series data. A historical time series data segment is retrieved using the feature extraction model after adaptation to the second domain. Anomalous behavior of the system in the second domain is detected based on the historical time series data segment. A corrective action is performed responsive to the anomalous behavior.

A system for training a model includes a hardware processor and memory that stores a computer program. When executed by the hardware processor, the computer program causes the hardware processor to train a feature extraction model to extract a feature vector from a multivariate time series segment, based on a set of training data corresponding to measurements of a system in a first domain, and to adapt the feature extraction model to a second domain, based on prototypes of the training data in the first domain and new time series data corresponding to measurements of the system in a second domain.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a cyber-physical system that is managed by a maintenance system 106, where the maintenance system can adapt to changes in operational domains by the cyber-physical system, in accordance with an embodiment of the present invention;

FIG. 2 is a block/flow diagram of a method for generating and storing prototypes of a system's behavior, in accordance with an embodiment of the present invention;

FIG. 3 is a block/flow diagram of a method for training a feature extraction model in a first domain of system operation, in accordance with an embodiment of the present invention;

FIG. 4 is a block/flow diagram of a method for updating a feature extraction model with training data from a second domain of system operation, in accordance with an embodiment of the present invention;

FIG. 5 is a block/flow diagram of a method for retrieving historical time series segments using a trained and updated feature extraction model, in accordance with an embodiment of the present invention;

FIG. 6 is a block diagram of a computing system that is configured to train and adapt a feature extraction model for multivariate time series data and to retrieve historical time series data segments based on a query, in accordance with an embodiment of the present invention;

FIG. 7 is a diagram of a neural network architecture that can be used to implement a feature extraction model, in accordance with an embodiment of the present invention; and

FIG. 8 is a diagram of a deep neural network architecture that can be used to implement a feature extraction model, in accordance with an embodiment of the present invention.

### DETAILED DESCRIPTION OF PREFERRED EMBODIMENTS

Multivariate time series retrieval is the task of finding the most relevant multivariate time series segments from a large volume of historical data. For example, recent sensor data from a cyber-physical system may be used to query the historical data to identify periods of time when the cyber-physical system was in a similar operational state. This information may be used to identify, for example, anomalous behavior in the system by correlating the current sensor measurements with previously identified anomalous behavior.

One way to perform multivariate time series retrieval is to obtain a compact representation of the historical data with binary codes that preserve relative similarity relations in the raw input space. These binary codes may be extracted by a hash function, for example using a deep neural network that is trained on the historical data. A binary code database can then be constructed to facilitate retrieval.

However, the binary codes and the neural network used to generate them can become outdated. For example, as conditions in the cyber-physical system change, the characteristic time series information for different operational states may also change. To address this, the binary code database and the hash function may be updated based on new time series information so that time series retrieval continues to work, even as the conditions change.

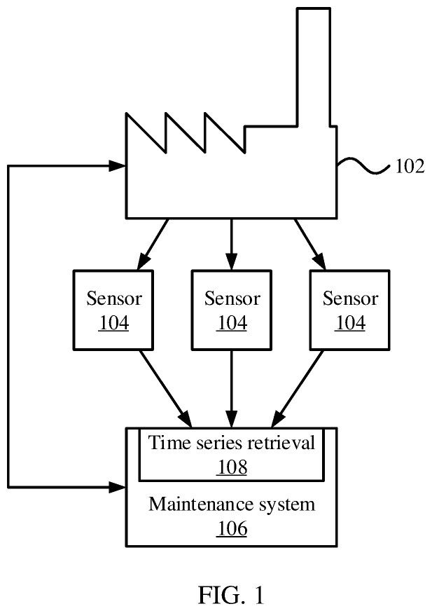

Referring now in detail to the figures in which like numerals represent the same or similar elements and initially to FIG. 1, a maintenance system 106 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems 102 may include a wide range of different types, including power plants, data centers, and transportation systems.

One or more sensors 104 record information about the state of the monitored system 102. The sensors 104 can be any appropriate type of sensor including, for example, physical sensors, such as temperature, humidity, vibration, pressure, voltage, current, magnetic field, electrical field, and light sensors, and software sensors, such as logging utilities installed on a computer system to record information regarding the state and behavior of the operating system and applications running on the computer system. The information generated by the sensors 104 can be in any appropriate format and can include sensor log information generated with heterogeneous formats.

The sensors 104 may transmit the logged sensor information to an anomaly maintenance system 106 by any appropriate communications medium and protocol, including wireless and wired communications. The maintenance system 106 can, for example, identify abnormal behavior by monitoring the multivariate time series that are generated by the sensors 104. Once anomalous behavior has been detected, the maintenance system 106 communicates with a system control unit to alter one or more parameters of the monitored system 102 to correct the anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects or mitigates the anomalous behavior. By identifying the particular sensors 104 that are associated with the anomalous classification, the amount of time needed to isolate a problem can be decreased.

Each of the sensors 104 outputs a respective time series, which encodes measurements made by the sensor over time. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering 100 measurements.

The time series segments may be marked by binary codes, where the binary codes of two similar raw time series segments reflect that similarity. In this manner, time series segments may be indexed in a database according to a relatively simple binary code, and queries to the database may be executed by comparing an input binary code to stored binary codes, with the time series associated with similar binary codes being returned. The identification of abnormal behavior may include time series retrieval 108, which may for example access the database of historical time series information to identify time series segments that are similar to a recently measured time series segment.

A binary code may be generated from a time series segment using an appropriate hashing function. The specific hashing function may be learned, for example using a neural network model, to preserve similarity information through the hash mapping. While such a hashing function may be defined once, on the assumption that training will occur under the same conditions as will prevail in practical scenarios, this assumption does not always hold. Domain shifts may occur between the source of the model and the target of the model. To address such domain shifts, a multivariate time series retrieval may be implemented that operates correctly even when the operating conditions change.

Thus, time series retrieval may adapt during runtime to new circumstances. A prototype selector may be used to select a set of representative samples that capture the characteristics of the input time series segments. The hashing function model may be updated with these prototypes, as well as a set of samples from the target domain.

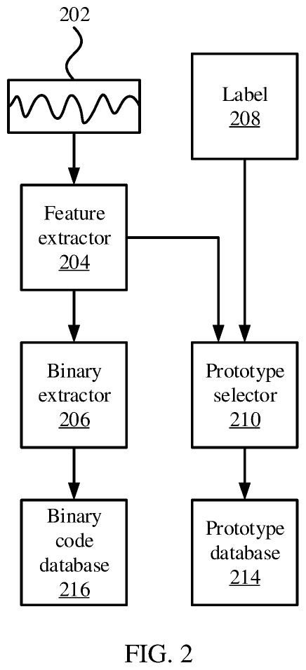

Referring now to FIG. 2, an architecture for generating binary codes and prototypes is shown. A multivariate time series 202 is provided as input, which may come from the sensors 104 of a cyber-physical system 102. A feature extractor 204 extracts a feature vector from the input time series 202. The feature extractor may use a sliding window to extract segments from the multivariate time series 202, and a sequence encoder may be used to extract the features of each segment. The sequence encoder may be implemented as a machine learning model, for example using recurrent neural network (RNN) layers, long-short term memory (LSTM) layers, gated recurrent unit (GRU) layers, and/or transformers.

A binary extractor 206 converts the feature vector to a binary code. For example, the binary code may have a same length as the feature vector and may simply convert the signs of the values in the feature vector to binary values. The extracted binary codes may be stored in binary code database 216. It should be understood that any appropriate hash function may be used by the binary extractor 206.

A prototype selector 210 selects representative input multivariate time series segments output by the feature extractor 204 based on associated labels 208. For examples, prototypes may be selected as the cluster centroid in a feature space of samples that are clustered in a same class. The labels may thereby be generated in an unsupervised manner, e.g., by clustering. The selected prototypes may be stored in a prototype database 214.

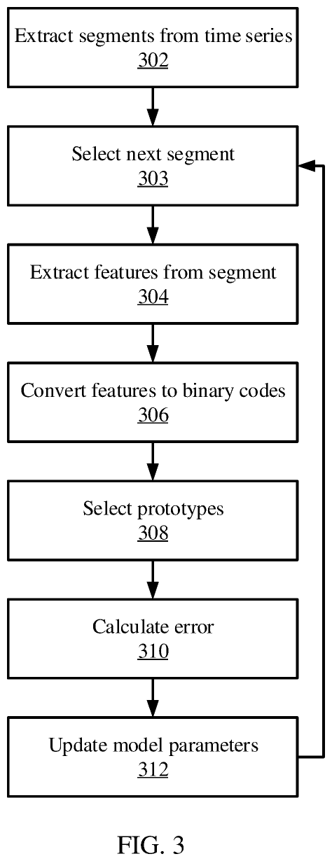

Referring now to FIG. 3, a method of pre-training the model is shown. Block 302 extracts segments from the multivariate time series that is generated by the sensors 104. The multivariate time series may be drawn from a set of training data that may include one or more distinct sets of multivariate time series information. The training data may have labels for the respective segments in a target domain. Segmenting the time series may be performed using a sliding window, which cuts the time series into segments having a same length, such that all measurements taken within a given window will be assigned to a same segment. The segments may be overlapping or non-overlapping.

Block 303 selects a segment. Block 304 then uses the feature extractor 204 to extract a feature vector from the selected segment. The feature vector is used by block 306 to generate a corresponding binary code, and by block 308 to select a prototype. As noted above, the binary extractor 206 may assign binary values to a code based on the sign of each value of the feature vector. The prototype may be stored in prototype database 214 and the binary code may be stored in binary code database 216. Block 310 uses the selected prototype and the binary code to calculate an error value, for example using a loss function. The error value may be used in block 312 to update the parameters of the model.

At this point, processing may return to block 303 to select a new segment from the time series. If no further segments are available, processing may stop and the training of the model may be finished with the latest updated set of parameters. Alternatively, training may stop once model parameters have converged, for example by comparing a difference between successive parameter values to a threshold, or once a maximum number of training iterations has been performed.

This pre-training process may be performed before the model has been exposed to current data during runtime of the cyber-physical system 102. Alternatively, the pre-training process may be considered as being performed prior to some change of conditions for the cyber-physical system 102. After such a change in condition, the parameters of the model may be adapted to reflect then new conditions.

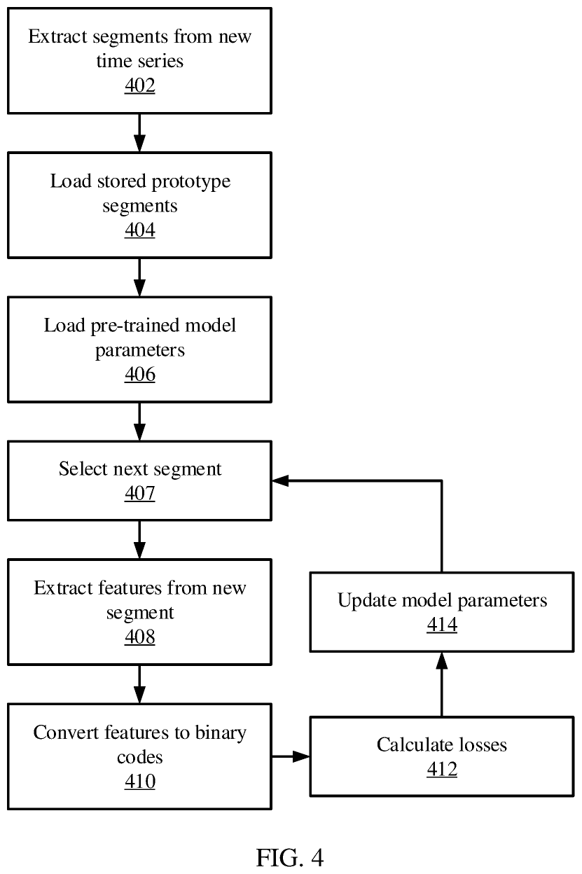

Referring now to FIG. 4, a method of adapting a model to new conditions of a system is shown. Block 402 extracts segments from new time series information, which has been collected after the conditions of a cyber-physical system 102 have changed. Block 404 loads the prototypes stored in prototype database 214 and block 406 loads the pre-trained model parameters.

Block 407 selects a segment of the multivariate time series information. Block 408 extracts a feature vector for the new segment and block 410 convers the feature vector to a binary code. Block 412 calculates a new error value based on the new binary code, and block 414 updates the model parameter accordingly. This process may repeat until convergence, with new segments being selected at each iteration, or until any other appropriate halting condition is met.

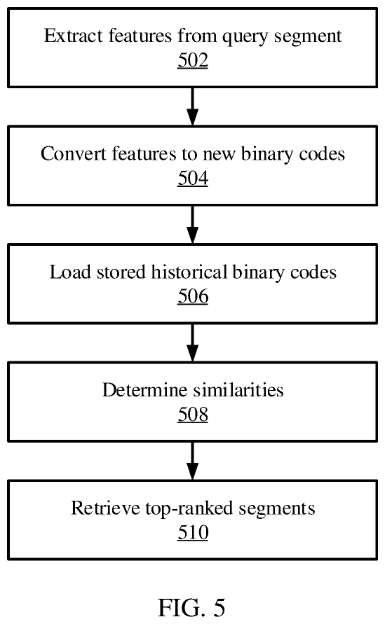

Referring now to FIG. 5, a method for using binary codes to retrieve similar time series segments is shown. A query segment is received, including multivariate time series data. Trained feature extractor 204 may be used to extract features from the query segment in block 502 and the binary extractor 206 may be used to convert the feature vector into a corresponding binary code in block 504.

Block 506 loads historical binary codes that are stored in the binary code database 216. Block 508 determines similarities between the new binary code corresponding to the query segment and the historical binary codes. This similarity may be determined as a pairwise comparison, with each binary value of the query code being compared to a corresponding binary value of the historical binary codes. For example, if the query code is <1111>, and a historical code is <1010>, then the similarity between those two codes may be two, for the number of binary values that they have in common.

Having compared the query code to a set of historical codes, block 510 retrieves the multivariate time series segments that correspond to the top-ranked historical codes. For example, a predetermined number of matches may be determined, corresponding to the top-n similarity scores. These matches, along with their similarity scores, may be returned as a response to the query.

During training and retrieval, feature selector 204 determines feature vectors that correspond to the multivariate time series segments. Each feature vector may be a vector of integer or real number values, and may include both positive and negative numbers. In some cases, the feature vectors may have only positive values or only negative values within a specified range (e.g., between 0 and 1), with binary codes being determined by comparison of the values to a threshold (e.g., 0.5).

The prototype selector 210 may be used during training and adaptation to summarize the training data distribution from the source domain. Prototypes may be selected in multiple different ways. For example, prototypes may be generated by clustering of feature vectors, or may be learned as trainable parameters.

To select prototypes using clustering, any appropriate clustering method may be used on the feature vectors. Exemplary clustering methods that are appropriate for this purpose include K-means clustering and hierarchical clustering. Prototypes may then be selected as centroids of each cluster. Letting Xₜ be a time series segment from the source domain at time t, 0≤t≤T, a feature f(Xₜ) may be extracted for each segment by a neural network f(⋅), which may be trained as described above. Clustering may be applied to all extracted features fₜ=f(Xₜ) to obtain a cluster assignment cₜ ϵ{1,...,K}. In this expression, T is a number of time slots and K is a number of clusters. The prototypes pₖ of the cluster Cₖ (with k ϵ{1, ...,K}) may then be selected as the centroid of the cluster:

$${p}_{k} = \frac{1}{{n}_{k}} {\sum }_{x ∈ {C}_{k}} f ( x )$$

where nₖ is the number of samples in the cluster C_{k.}

To select prototypes as trainable parameters, prototypes may be jointly trained with the model parameters during training. With pₖ as a prototype of the cluster Cₖ in feature space, for each extracted feature fₖ, the probability of belonging to each cluster can be represented as:

$${s}_{t} = \frac{{( 1 + {‖ {f}_{t} - p ‖}^{2} )}^{- 1}}{{\sum }_{{k}^{′}} {( 1 + {‖ {f}_{t} - {p}_{{k}^{′}} ‖}^{2} )}^{- 1}} ∈ {[ 0 , 1 ]}^{K}$$

The probability sₜ is a K-dimensional vector, with each i^{th} entry representing the probability of belonging to the cluster Cₖ for a feature fₜ. During pre-training, the prototypes may be evaluated by a Kullback-Leibler triplet loss and evidence regularization. The Kullback-Leibler loss may be expressed as:

$${\sum }_{( a , p , n )} {( K L ( {s}_{a} \vert \vert {s}_{p} ) - K L ( {s}_{a} \vert {s}_{n} ) + α )}_{+}$$

where KL(p∥q) represents the Kullback-Leibler divergence between the two probabilistic distributions p and q. Evidence regularization may be expressed as

$${\sum }_{i} {min}_{k} ‖ {f}_{i} - {p}_{k} ‖ ,$$

clustering regularization may be expressed as

$${\sum }_{k} {min}_{i} ‖ {p}_{k} - {f}_{i} ‖ ,$$

and diversity regularization may be expressed as Σ_{k<l}(dₘᵢₙ−∥pₖ−pₗ∥)₊. The prototypes may be updated by stochastic gradient descent with the other neural network parameters.

The selected prototypes may be used to combine raw time series segments from prior to the conditions with raw time series segments from new samples, taken after conditions in the system change. Thus {X, y} may be a relatively small number of labeled time series segments from the new domain. The pre-trained model may then be fine-tuned with {X, y} as well as {Xₚ_{ₖ}, yₚ_{ₖ}}, where f(Xₚ_{ₖ})=pₖ.

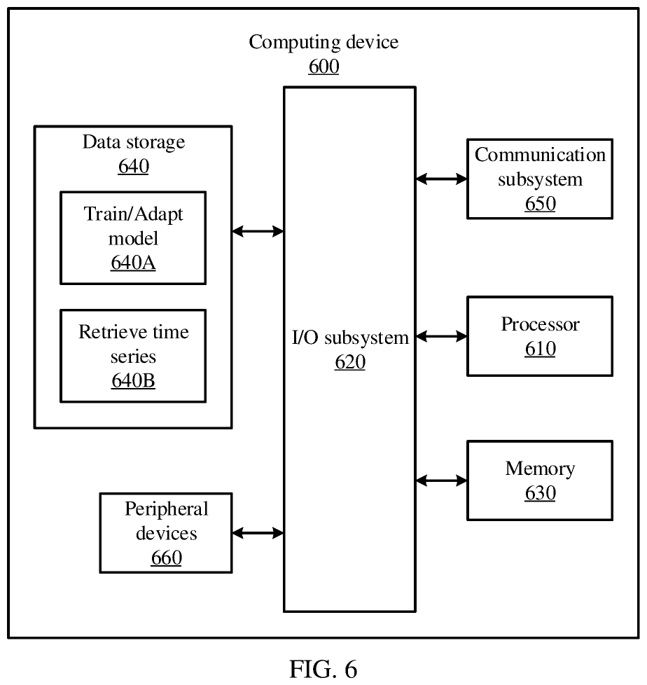

Referring now to FIG. 6, an exemplary computing device 600 is shown, in accordance with an embodiment of the present invention. The computing device 600 is configured to perform classifier enhancement.

The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as a one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for training and adapting a feature extraction model and program code 640B for retrieving time series information based on a query. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

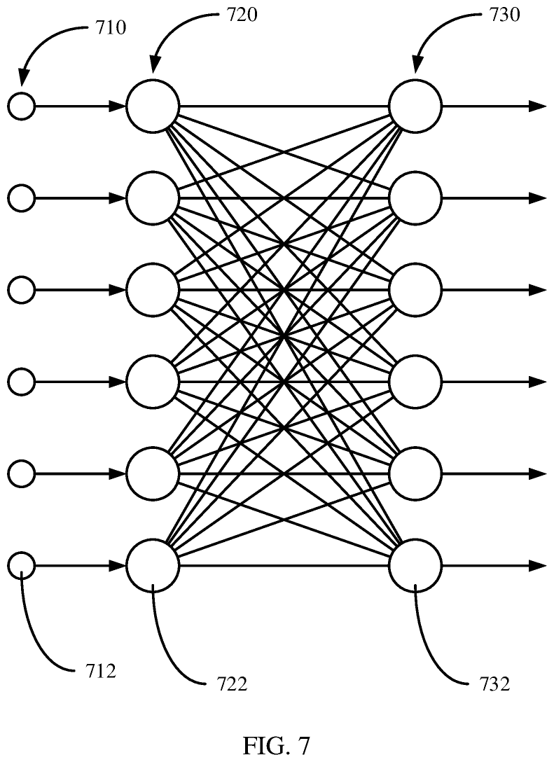

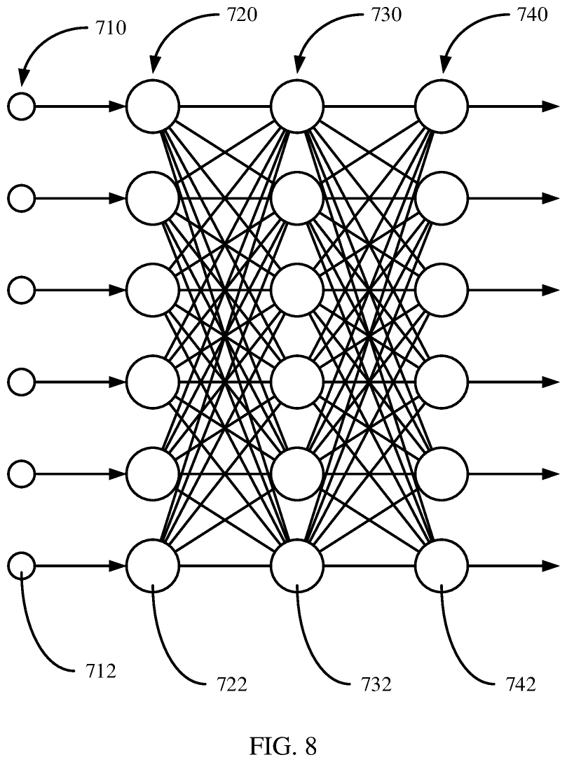

Referring now to FIGS. 7 and 8, exemplary neural network architectures are shown, which may be used to implement parts of the present models. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, ... wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
training a feature extraction model to extract a feature vector from a multivariate time series segment, based on a set of training data corresponding to measurements of a system in a first domain; and
adapting the feature extraction model to a second domain, based on prototypes of the training data in the first domain and new time series data corresponding to measurements of the system in a second domain.

2. The method of claim 1, further comprising identifying the prototypes of the training data in the first domain by clustering multivariate time series segments of the training data in the first domain to generate clusters.

3. The method of claim 2, wherein identifying the prototypes of the training data in the first domain further includes selecting centroids of the clusters as the prototypes.

4. The method of claim 1, further comprising identifying the prototypes of the training data in the first domain by expressing the prototypes as parameters of a neural network model and training the parameters jointly with the feature extraction model.

5. The method of claim 1, further comprising identifying the prototypes of the training data in the first domain and storing a corresponding binary code of each prototype.

6. The method of claim 5, wherein each binary code includes binary values corresponding to values of a respective feature vector.

7. The method of claim 6, further comprising determining the binary code corresponding to the respective feature vector by comparing values of the feature vector to a threshold value.

8. The method of claim 1, further comprising collecting the new time series data from a plurality of sensors and splitting the new time series data into new multivariate time series segments.

9. A computer-implemented method for anomaly detection, comprising:
training a feature extraction model to extract a feature vector from a multivariate time series segment, based on a set of training data corresponding to measurements of a system in a first domain;
collecting new time series data from a plurality of sensors, the new time series data corresponding to a second domain of the system;
adapting the feature extraction model to a second domain, based on prototypes of the training data in the first domain and the new time series data;
retrieving a historical time series data segment using the feature extraction model after adaptation to the second domain;
detecting anomalous behavior of the system in the second domain based on the historical time series data segment; and
performing a corrective action responsive to the anomalous behavior.

10. The method of claim 9, further comprising identifying the prototypes of the training data in the first domain by clustering multivariate time series segments of the training data in the first domain to generate clusters.

11. The method of claim 10, wherein identifying the prototypes of the training data in the first domain further includes selecting centroids of the clusters as the prototypes.

12. The method of claim 9, further comprising identifying the prototypes of the training data in the first domain by expressing the prototypes as parameters of a neural network model and training the parameters jointly with the feature extraction model.

13. A system for training a model, comprising:
a hardware processor; and
a memory that stores a computer program, which, when executed by the hardware processor, causes the hardware processor to:
train a feature extraction model to extract a feature vector from a multivariate time series segment, based on a set of training data corresponding to measurements of a system in a first domain; and
adapt the feature extraction model to a second domain, based on prototypes of the training data in the first domain and new time series data corresponding to measurements of the system in a second domain.

14. The system of claim 13, wherein the computer program further causes the hardware processor to identify the prototypes of the training data in the first domain by clustering multivariate time series segments of the training data in the first domain to generate clusters.

15. The system of claim 14, wherein the computer program further causes the hardware processor to select centroids of the clusters as the prototypes.

16. The system of claim 13, wherein the computer program further causes the hardware processor to identify the prototypes of the training data in the first domain by expressing the prototypes as parameters of a neural network model and to train the parameters jointly with the feature extraction model.

17. The system of claim 13, wherein the computer program further causes the hardware processor to identify the prototypes of the training data in the first domain and storing a corresponding binary code of each prototype.

18. The system of claim 17, wherein each binary code includes binary values corresponding to values of a respective feature vector.

19. The system of claim 18, wherein the computer program further causes the hardware processor to determine the binary code corresponding to the respective feature vector by comparing values of the feature vector to a threshold value.

20. The system of claim 13, wherein the computer program further causes the hardware processor to collect the new time series data from a plurality of sensors and splitting the new time series data into new multivariate time series segments.
